(19) United States
(12) Patent Application Publication
(10) Pub. No.: US 2012/0077918 A1
(43) Pub. Date: Mar. 29, 2012

(54) MIXTURES CONTAINING EFFECTIVE MATERIALS AND INORGANIC COMPOUNDS WITH HIGH SURFACE AREA

(75) Inventors: Alban GLASER, Mannheim (DE); Rainer DYLLICK-BRENZINGER, Neustadt (DE); Samira NOZARI, Mannheim (DE)

(73) Assignee: BASF SE, Ludwigshafen (DE)

(21) Appl. No.: 13/173,257

(22) Filed: Jun. 30, 2011

Related U.S. Application Data
(60) Provisional application No. 61/360,526, filed on Jul. 1, 2010.

(51) Int. Cl. C09K 15/02; C08K 3/36; C09D 7/12; C08K 3/26

(52) U.S. Cl. 524/425; 252/397; 524/493

(57) ABSTRACT

Mixtures comprising inorganic compounds and effect substances, where the inorganic compounds are present as agglomerates and these agglomerates have a specific surface area greater than 10 m²/g, a particle size of from 1 to 20 μm, a loss on ignition of from 1 to 20%, a carbon content of from 0.1 to 5%, a methanol wettability of from 10 to 90% and an effect substance absorption of from 100 g to 4000 g, based on 100 g of inorganic compound. These mixtures comprise, as effect substances, UV absorbers, stabilizers, antioxidants, flame retardants, antifogging additives, lubricants, plasticizers, antistats, dyes, optical brighteners, IR dyes or biocides. The inorganic compounds are selected from the group of oxides, carbonates, hydrogencarbonates, phosphates, sulfates, hydroxides, silicates and sulfides and comprise alkali metal, alkaline earth metal or transition metals. The mixtures are used in the processing or the use of inanimate organic materials, for example in the protection of inanimate organic materials such as polymers or coatings against oxidative, thermal or light-induced degradation or the effect of UV radiation.

The present invention relates to mixtures comprising inorganic compounds and effect substances, or agglomerates comprising effect substances. The invention further provides processes for producing these mixtures. The use of such mixtures, in particular with UV absorbers or antioxidants, e.g. in the finishing of plastics to protect against oxidative, thermal and/or light-induced degradation is likewise provided by the invention. Further subjects of the invention are inanimate organic materials which comprise these mixtures and processes for stabilizing inanimate organic materials through the addition of specific mixtures such as these. The invention further provides the use of specific inorganic compounds as carriers for effect substances.

Further embodiments of the present invention can be found in the claims, the description and the examples. It goes without saying that the features specified above and still to be explained below of the subject matter according to the invention can be used not only in the combinations specifically stated in each case, but also in other combinations without departing from the scope of the invention. The embodiments of the present invention in which all of the features have the preferred or very preferred meanings are preferred or very preferred, respectively.

The fixing of organic compounds to carriers, or the coating of fillers with organic compounds, is known and described, for example, in U.S. Pat. No. 4,283,316.

Compositions for the additization of resins comprising pulverulent inorganic material which is impregnated with a resin additive, and also resin compositions comprising these are known from EP 1 897 914 A1. As possible resin additives, EP 1 897 914 A1 mentions phenol-based antioxidants, UV absorbers, or sterically hindered amines, which are intended to prevent the aging of resins caused by light or heat.

EP 0 745 646 A1 describes antioxidants and light stabilizers fixed on carriers, compositions comprising an organic material, preferably a polymer, and the antioxidants and light stabilizers fixed on carriers, and also the use thereof as fillers and for stabilizing organic materials against oxidative, thermal and/or light-induced degradation.

WO 2006/008240 A1 describes porous silica which comprises polymer additives in the pores in order to improve the effectiveness of the additives.

EP 0 259 960 A2 describes a polymer additive concentrate which comprises 15 to 80% of a liquid, pasty or wax-like additive, 5 to 50% of a particulate solid and at least 5% of a polymer. The particle size of the solid is in the micrometer range.

U.S. Pat. No. 3,998,781 describes processes for producing mixtures comprising polyolefins, amorphous silica, and also a high fraction of UV absorbers.

As a rule, the mixtures known from the prior art have increased migration stability following their incorporation into inanimate organic materials such as plastics (polymers). However, there is a further need to additionally increase the migration stability of effect substances which are distributed in inanimate organic materials, in particular in polymers, in order to prevent, or significantly slow, the escape of the effect substance, and thus generally the loss or the reduction in its effect, from the material.

Furthermore, as well as the homogeneous distribution of effect substances in the end use and the individual production steps, it is also often desired for the loss of effect substances during processing to be lower. Effect substances which simply permit a homogeneous distribution often have a tendency, during processing, to escape from the materials and to settle, for example, on apparatuses or to accumulate in the surrounding area. For example, the processing of plastics additives often takes place by means of extrusion processes (masterbatch production and/or end processing by means of film production, injection molding, fiber production, etc.). The plastics additives here often escape from the hot melt and settle on the production machine (e.g. the extruder). As a result, frequent cleaning cycles are necessary. If the escape were reduced, as well as the advantage of shorter machine down-times, environmental protection and safety of personnel would naturally also be of importance. For the same effect in the end product, less effect substance has to be supplied at the start of the production process, which, inter alia, brings with it a cost advantage.

Furthermore, effect substances have an increased tendency to escape from the inanimate organic materials during the formation of surface layers or covering layers, e.g. of coating layers. It was therefore a further object of the invention to provide effect substances in a form which makes it possible to minimize the escape of effect substances from these layers, e.g. during the formation of a coating layer and when using these layers. In particular, it is desirable that during a UV drying, thermal drying or IR drying, fewer losses of effect substances arise during the build-up of the layers. Likewise, a lower loss of additives is established during extrusion.

As can be seen from the disclosure content of the present invention, these and other objects are achieved by the various embodiments of the mixtures according to the invention which are described below.

Surprisingly, it has been found that these objects are achieved by mixtures comprising inorganic compounds and effect substances, where the inorganic compounds are present as agglomerates and these agglomerates have
a. a specific surface area greater than 10 m²/g,
b. a particle size of from 1 to 20 μm,
c. a loss on ignition of from 1 to 20%,
d. a carbon content of from 0.1 to 5%,
e. a methanol wettability of from 10 to 90%,
f. an effect substance absorption of from 100 g to 4000 g, based in each case on 100 g of inorganic compound.

The agglomerates are generally the greater or lesser loose cohesion of primary particles to give larger structures, where these do not have to have a certain shape. Thus, these agglomerates can be shaped for example like rods, beads or ellipsoids, or else irregularly with uneven surfaces. The primary particles here generally have a particle size of from 0.05 μm to 5 μm. They are in most cases predominantly crystalline solids which are produced by precipitation processes from aqueous phase in crystalline form, in most cases already as agglomerates and are then optionally given a hydrophobic finish by means of subsequent chemical modification.

Preferably, the agglomerates in the mixtures according to the invention have a high specific surface area (a.) of more than 50 m²/g, which is measured in accordance with ISO 5794-1, Annex D with nitrogen with the help of an areameter. Particularly preferably, the specific surface area is greater than or equal to 80 m²/g and in particular the specific surface area is from 80 m²/g to 200 m²/g.

Preferably, the agglomerates in the mixtures according to the invention have a particle size (d50), measured with laser diffraction in accordance with ISO 13320-1, of from 2 to 18 μm. Particularly preferably, this particle size (b.) is from 5 to 15 μm and in particular the particle size (b.) is from 8 to 12 μm.

Preferably, the agglomerates in the mixtures according to the invention have a loss on ignition (c.), determined in accordance with ISO 3262-1 at 1000° C. (2 hours), of 2 to 15%. Particularly preferably, this loss on ignition (c.) is from 3 to 12% and in particular the loss on ignition is from 4 to 10%.

Preferably, the agglomerates in the mixtures according to the invention have a carbon content (d.), determined by elemental analysis, of from 0.5 to 4%. Particularly preferably, this carbon content is from 0.7 to 3.5% and in particular the carbon content is from 1 to 3%.

Preferably, the agglomerates of the mixtures according to the invention have a methanol wettability (e.), of from 20 to 80%. Particularly preferably, this methanol wettability is from 30 to 70% and in particular the methanol wettability is from 50 to 60%. The methanol wettability is a measure for how hydrophobic an agglomerate of the inorganic compounds is. In the method for determining the methanol wettability, the agglomerates are wetted using a methanol/water mixture. The fraction of methanol in the mixture of agglomerate and water/methanol mixture, expressed as percent by weight (methanol wettability), is a measure of the water repellency of the agglomerate. The higher the fraction of methanol, the better the substance is hydrophobicized. Typically, an agglomerate is subjected to tests with different concentrations of methanol/water mixtures which are prepared with increasing methanol increments of e.g. 5%. The agglomerate here is weighed into individual glass ampoules (e.g. 10 ml) and provided with the respective methanol/water mixture. Each ampoule then receives (e.g. 8 ml of) the respective methanol/water mixture, the ampoule is shaken vigorously and left to stand without movement for 30 minutes. The agglomerate-methanol/water mixtures are then investigated in order to determine whether wetting has taken place. Typically, for a pregiven ratio of methanol/water, it is not assumed that wetting has occurred if the entire agglomerate floats on the methanol/water mixture and the methanol/water mixture is not cloudy or the majority of the agglomerate floats in a cloudy lower layer. Trace amounts of agglomerate can be established at the bottom of the ampoule. Wetting for a pregiven ratio of methanol/water is considered to have taken place if the majority of the agglomerate is wetted, but trace amounts are still floating, no agglomerate is floating, but no clear upper layer of methanol/water is established or the entire agglomerate is wetted and a clear methanol/water layer is established on the upper side of the agglomerate. The methanol wettability is given in percent by weight methanol of the ratio of the first methanol/water mixture which indicates that wetting has taken place.

Preferably, the agglomerates in the mixtures according to the invention have an effect substance absorption (f.), determined by the method described below in accordance with DIN 53601, of from 200 to 2500 g, based on 100 g of inorganic compound. Particularly preferably, this Uvinul absorption is from 500 to 2000 g and in particular the effect substance absorption is from 1000 to 2000 g, based on 100 g of inorganic compound.

In a preferred embodiment of the mixtures according to the invention, the agglomerates have a specific surface area (a.) greater than or equal to 80 m²/g and a particle size (b.) of from 5 to 15 μm and a loss on ignition (c.) of from 3 to 12% and a carbon content (d.) of from 0.7 to 3.5% and a methanol wettability (e.) of from 30 to 70% and an effect substance absorption (f.) of from 500 to 2000 g, based on 100 g of inorganic compound.

In a particularly preferred embodiment of the mixtures according to the invention, the agglomerates have a specific surface area (a.) of from 80 m²/g to 200 m²/g and a particle size (b.) of from 8 to 12 μm and a loss on ignition (c.) of from 4 to 10% and a carbon content (d.) of from 1 to 3% and a methanol wettability (e.) of from 50 to 60% and an effect substance absorption (f.) of from 1000 to 2000 g, based on 100 g of inorganic compound.

In one embodiment of the mixture according to the invention, the agglomerates have the maximum of the differential pore volume at an average pore diameter of from 30 to 60 nm, where the pore volume and the pore diameter are determined with the help of mercury porosimetry (Washburn equation). Preferably, the maximum of the differential pore volume is at an average pore diameter of from 40 to 50 nm.

In a preferred embodiment of the mixtures according to the invention, the agglomerates have a specific surface area (a.) greater than or equal to 80 m²/g and a particle size (b.) of from 5 to 15 μm and a loss on ignition (c.) of from 3 to 12% and a carbon content (d.) of from 0.7 to 3.5% and a methanol wettability (e.) of from 30 to 70% and an effect substance absorption (f.) of from 500 to 2000 g, based on 100 g of inorganic compound and the maximum of the differential pore volume at an average pore diameter of from 30 to 60 nm.

In a particularly preferred embodiment of the mixtures according to the invention, the agglomerates have a specific surface area (a.) of from 80 m²/g to 200 m²/g and a particle size (b.) of from 8 to 12 μm and a loss on ignition (c.) of from 4 to 10% and a carbon content (d.) of from 1 to 3% and a methanol wettability (e.) of from 50 to 60% and an effect substance absorption (f.) of from 1000 to 2000 g, based on 100 g of inorganic compound and the maximum of the differential pore volume at an average pore diameter of from 40 to 50 nm.

In one embodiment of the mixture according to the invention, the agglomerates in a 5% strength aqueous suspension in an MeOH/water mixture have a pH of from 6.1 to 8.1.

In a particularly preferred embodiment of the mixtures according to the invention, the agglomerates have a specific surface area (a.) of from 80 m²/g to 200 m²/g and a particle size (b.) of from 8 to 12 μm and a loss on ignition (c.) of from 4 to 10% and a carbon content (d.) of from 1 to 3% and a methanol wettability (e.) of from 50 to 60% and an effect substance absorption (f.) of from 1000 to 2000 g, based on 100 g of inorganic compound and the maximum of the differential pore volume at an average pore diameter of from 40 to 50 nm and a pH of from 6.1 to 8.1 in aqueous suspension.

In one embodiment of the mixture according to the invention, the agglomerates have a water absorption at 30° C. and 30% rh (relative humidity) of from 0.8% to 1.6%.

In a further particularly preferred embodiment of the mixtures according to the invention, the agglomerates have a specific surface area (a.) of from 80 m²/g to 200 m²/g and a particle size (b.) of from 8 to 12 μm and a loss on ignition (c.) of from 4 to 10% and a carbon content (d.) of from 1 to 3% and a methanol wettability (e.) of from 50 to 60% and an effect substance absorption (f.) of from 1000 to 2000 g, based on 100 g of inorganic compound and the maximum of the differential pore volume at an average pore diameter of from 40 to 50 nm and a pH of from 6.1 to 8.1 in aqueous suspension and a water absorption at 30° C. and 30% rh of from 0.8% to 1.6%.

In one embodiment of the mixture according to the invention, the agglomerates in a 5% strength by weight aqueous-methanolic dispersion (water:methanol=1:1 weight ratio) have a conductivity of from 50 to 300 μS in accordance with ISO 787-9.

In a further particularly preferred embodiment of the mixtures according to the invention, the agglomerates have a specific surface area (a.) of from 80 m²/g to 200 m²/g and a particle size (b.) of from 8 to 12 μm and a loss on ignition (c.) of from 4 to 10% and a carbon content (d.) of from 1 to 3% and a methanol wettability (e.) of from 50 to 60% and an effect substance absorption (f.) of from 1000 to 2000 g, based on 100 g of inorganic compound and the maximum of the differential pore volume at an average pore diameter of from 40 to 50 nm and a pH of from 6.1 to 8.1 in aqueous suspension and a water absorption at 30° C. and 30% rh of from 0.8% to 1.6% and in a 4% strength by weight aqueous-methanolic dispersion a conductivity of from 50 to 300 μS.

The content of effect substances can vary in a wide range depending, for example, on the intended use of the mixtures. As a rule, an amount of from 5 to 99% by weight of effect substances, based on the total amount of effect substances and inorganic compound in the mixture, is used. Preference is given to from 30 to 98% by weight of effect substances, particularly preferably from 50 to 97% by weight and in particular from 70 to 95% by weight.

Within the context of the present invention, “effect substances” is the term used to refer to those substances which, optionally after being brought into contact with inanimate organic materials or following incorporation into inanimate organic materials, bring about a desired effect. Preferably, plastics additives are to be mentioned as effect substances.

Plastics additives are, for example, UV absorbers, stabilizers, antioxidants, flame retardants, antifogging additives, lubricants, plasticizers, antistats, dyes, optical brighteners, IR dyes or biocides. Preferred plastics additives are UV absorbers, stabilizers, in particular sterically hindered amines (HALS) or antioxidants. Within the context of the mixture according to the invention, it is of course also possible to use mixtures of different effect substances.

Particularly preferred effect substances are UV absorbers.

UV absorbers are often commercial products. They are sold, for example, under the trade name Uvinul®, Chimassorb®, for example Chimassorb® 81 or Tinuvin® from BASF SE. The UV absorbers comprise compounds of the following classes: benzophenones, benzotriazoles, cyanoacrylates, cinnamic acid esters, para-aminobenzoates, naphthalimides. Moreover, further known chromophores are used, e.g. hydroxyphenyltriazines or oxalanilides. Such compounds are used, for example, on their own or in mixtures with other photoprotective agents in cosmetic applications, for example sunscreen compositions or for stabilizing organic polymers. Further examples of UV absorbers are:

substituted acrylates, such as e.g. ethyl or isooctyl α-cyano-β,β-diphenylacrylate (primarily 2-ethylhexyl α-cyano-β,β-diphenylacrylate), methyl α-methoxycarbonyl-β-phenylacrylate, methyl α-methoxycarbonyl-β-(p-methoxyphenyl)acrylate, methyl or butyl α-cyano-β-methyl-β-(p-methoxyphenyl)acrylate, N-(β-methoxycarbonyl-β-cyanovinyl)-2-methylindoline, octyl p-methoxycinnamate, isopentyl 4-methoxycinnamate, urocanic acid or salts or esters thereof;
derivatives of p-aminobenzoic acid, in particular esters thereof, e.g. ethyl 4-aminobenzoate or ethoxylated ethyl 4-aminobenzoate, salicylates, substituted cinnamic acid esters (cinnamates) such as octyl p-methoxycinnamate or 4-isopentyl 4-methoxycinnamate, 2-phenylbenzimidazole-5-sulfonic acid or its salts.
2-Hydroxybenzophenone derivatives, such as e.g. 4-hydroxy-, 4-methoxy-, 4-octyloxy-, 4-decyloxy-, 4-dodecyloxy-, 4-benzyloxy-, 4,2′,4′-trihydroxy-, 2′-hydroxy-4,4′-dimethoxy-2-hydroxybenzophenone, and 4-methoxy-2-hydroxybenzophenonesulfonic acid sodium salt;
esters of 4,4-diphenylbutadiene-1,1-dicarboxylic acid, such as e.g. the bis(2-ethylhexyl) ester;
2-phenylbenzimidazole-4-sulfonic acid and 2-phenylbenzimidazole-5-sulfonic acid or salts thereof;
derivatives of benzoxazoles;
derivatives of benzotriazoles or 2-(2′-hydroxyphenyl)benzotriazoles, such as e.g. 2-(2H-benzotriazol-2-yl)-4-methyl-6-(2-methyl-3-((1,1,3,3-tetramethyl-1-(trimethylsilyloxy)disiloxanyl)propyl)phenol, 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-[2′-hydroxy-5′-(1,1,3,3-tetramethylbutyl)phenyl]benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-[3′,5′-bis(α,α-dimethylbenzyl)-2′-hydroxyphenyl]benzotriazole, 2-[3′-tert-butyl-2′-hydroxy-5′-(2-octyloxycarbonylethyl)phenyl]-5-chlorobenzotriazole, 2-[3′-tert-butyl-5′-(2-(2-ethylhexyloxy)carbonylethyl)-2′-hydroxyphenyl]-5-chlorobenzotriazole, 2-[3′-tert-butyl-2′-hydroxy-5′-(2-methoxycarbonylethyl)phenyl]-5-chlorobenzotriazole, 2-[3′-tert-butyl-2′-hydroxy-5′-(2-methoxycarbonylethyl)phenyl]benzotriazole, 2-[3′-tert-butyl-2′-hydroxy-5′-(2-octyloxycarbonylethyl)phenyl]benzotriazole, 2-[3′-tert-butyl-5′-(2-(2-ethylhexyloxy)carbonylethyl)-2′-hydroxyphenyl]benzotriazole, 2-(3′-dodecyl-2′-hydroxy-5′-methylphenyl)benzotriazole, 2-[3′-tert-butyl-2′-hydroxy-5′-(2-isooctyloxycarbonylethyl)phenyl]benzotriazole, 2,2′-methylenebis[4-(1,1,3,3-tetramethylbutyl)-6-benzotriazol-2-ylphenol], the completely esterified product of 2-[3′-tert-butyl-5′-(2-methoxycarbonylethyl)-2′-hydroxyphenyl]-2H-benzotriazole with polyethylene glycol 300, [R—CH2CH2-COO(CH2)3-]2 where R is 3′-tert-butyl-4-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole, 2-[2′-hydroxy-3′-(1,1,3,3-tetramethylbutyl)-5′-(α,α-dimethylbenzyl)phenyl]benzotriazole;
benzylidenecamphor or its derivatives, as are specified e.g. in DE-A 38 36 630, e.g. 3-benzylidenecamphor, 3-(4′-methylbenzylidene)-dl-camphor;
α-(2-oxoborn-3-ylidene)toluene-4-sulfonic acid or its salts, N,N,N-trimethyl-4-(2-oxoborn-3-ylidenemethyl)anilinium monosulfate;
dibenzoylmethanes, such as e.g. 4-tert-butyl-4′-methoxydibenzoylmethane;
2,4,6-triaryltriazine compounds such as 2,4,6-tris{N-[4-(2-ethylhex-1-yl)oxycarbonylphenyl]amino}-1,3,5-triazine, bis(2′-ethylhexyl) 4,4′-((6-(((tert-butyl)aminocarbonyl)phenylamino)-1,3,5-triazine-2,4-diyl)imino)bisbenzoate;
2-(2-hydroxyphenyl)-1,3,5-triazines, such as e.g. 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxypropyloxy)phenyl]-4,6-bis(2,4-dimethylphenyl)-1,3,5-triazine, 2-[2-hydroxy-4-(2-hydroxy-3-octyloxypropyloxy)phenyl]-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

Further suitable UV absorbers can be found in the publication Cosmetic Legislation, Vol. 1, Cosmetic Products, European Commission 1999, p. 64-66, to which reference is hereby made.

Suitable UV absorbers are moreover described in lines 14 to 30 ([0030]) on page 6 of EP 1 191 041 A2. Reference is made to this in its entirety and this literature passage forms part of the disclosure of the present invention.

Preferably, the UV absorbers which are used in the mixture according to the invention as effect substances have a molar mass of from 100 to 1000 g/mol. The molar mass is preferably from 150 to 800 g/mol, in particular from 200 to 500 g/mol.

Preferably, the UV absorbers which are used in the mixture according to the invention as effect substances have a melting point (pressure 1 atm) of from 30 to 200° C. Preferably, the melting point is from 40 to 190° C., in particular from 45 to 180° C. at a pressure of 1 atm.

Particularly preferred UV absorbers are 1,3-bis[2′-cyano-3′,3-diphenylacryloyl)oxy]-2,2-bis{[2-cyano-3′,3′-diphenylacryloyl)oxy]methyl}propane (Uvinul® 3030, CAS 178671-58-4), ethyl cyanoacrylate (Uvinul® 3035, CAS 5232-99-5), ethylhexyl cyanoacrylate (Uvinul® 3039, CAS 6197-30-4).

Further preferred effect substances are stabilizers.

Suitable stabilizers, particularly when the inanimate organic materials are plastics, are stabilizers for plastics. These stabilizers are compounds which stabilize the plastics against degradation upon the action of oxygen, light (visible, infrared and/or ultraviolet light) or heat. They are also referred to as antioxidants, free-radical scavengers or as light stabilizers, cf. Ullmann's Encyclopedia of Industrial Chemistry, Vol. 3, 629-650 (ISBN-3-527-30385-5) and EP-A 1 110 999, page 2, line 29 to page 38, line 29. Such stabilizers can be used to stabilize virtually all plastics, cf. EP-A 1 110 999, page 38, line 30 to page 41, line 35. This passage forms part of the disclosure of the present invention by reference. The stabilizers described in the EP application belong to the compound class of pyrazolones, of organic phosphites or phosphonites, the sterically hindered phenols and the sterically hindered amines (stabilizers of the so-called HALS type or HALS stabilizers, cf. Römpp, 10th edition, volume 5, pages 4206-4207.

Suitable effect substances are therefore furthermore preferably HALS stabilizers.

HALS stabilizers are often commercial products. They are sold, for example, under the trade name Uvinul®, Chimassorb®, for example Chimassorb® 944 or Tinuvin® from BASF SE. Examples include Tinuvin 770 (CAS No. 52829-07-9), Uvinul 4050 H (CAS No. 124172-53-8) or Uvinul 5050 (CAS No. 93924-10-8).

The HALS stabilizers comprise compounds comprising groups of formula II a or those of formula II b,

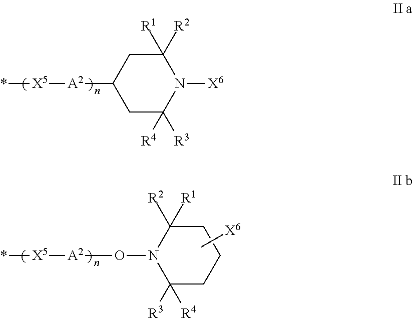

where the variables are defined as follows:
R¹, R², R³ and R⁴ are identical or different and, independently of one another, are C₁-C₁₂-alkyl such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl such as methyl, ethyl, n-propyl, isopropyl, n-butyl, isobutyl, sec-butyl and tert-butyl, in particular, R¹, R², R³ and R⁴ are in each case the same and are each methyl,
   C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl,
X⁵ is an oxygen atom, a sulfur atom, a NH group, a N—(C₁-C₄-alkyl) group, a carbonyl group,
A² is a single bond or a spacer. Examples of spacers A2 are para-phenylene, meta-phenylene, preferably C₁-C₂₀-alkylene, branched or unbranched, where optionally one to 6 non-adjacent CH₂ groups can be replaced by in each case one sulfur atom, including oxidized, or one oxygen atom. By way of example, mention may be made of the following spacers:
   —CH₂—, —CH₂—CH₂—, —(CH₂)₃—, —(CH₂)⁴—, —(CH₂)⁵—, —(CH₂)₆—, —(CH₂)₇—, —(CH₂)₈—, —(CH₂)₉—, —(CH₂)₁₀—, —(CH₂)₁₂—, —(CH₂)₁₄—, —(CH₂)₁₆—, —(CH₂)₁₈—, —(CH₂)₂₀—, —CH₂—CH(CH₃)—, —CH₂—CH(C₂H₅)—, —CH₂—CH(CH[CH₃]₂)—, —CH₂—CH(n-C₃H₇)—, —[CH(CH₃)]₂—, —CH(CH₃)—CH₂—CH₂—CH(CH₃)—, —CH(CH₃)—CH₂—CH(CH₃)—, —CH₂—C(CH₃)₂—CH₂—, —CH₂—CH(n-C₄H₉)—, —CH₂—CH(iso-C₃H₇)—, —CH₂—CH(tert-C₄H₉)—,
   —CH₂—O—, —CH₂—O—CH₂—, —(CH₂)₂—O—(CH₂)₂—, —[(CH₂)₂—O]₂—(CH₂)₂—, —[(CH₂)₂—O]₃—(CH₂)₂—,
   —CH₂—S—, —CH₂—S—CH₂—, —(CH₂)₂—S—(CH₂)₂—, —[(CH₂)₂—S]₂—(CH₂)₂—, —[(CH₂)₂—S]₃—(CH₂)₂—, —CH₂—SO—CH₂—, —CH₂—SO₂—CH₂—,
   preferred spacers A² are C₂-C₁₀-alkylene groups, branched or unbranched, such as —CH₂—CH₂—, —(CH₂)₃—, —(CH₂)₄—, —(CH₂)₅—, —(CH₂)₆—, —(CH₂)₇—, —(CH₂)₈—, —(CH₂)₉—, —(CH₂)₁₀—,
n is zero or one
X⁶ is hydrogen, oxygen, O—C₁-C₁₉-alkyl, preferably C₁-C₆-alkoxy groups such as methoxy, ethoxy, n-propoxy, isopropoxy, n-butoxy, isobutoxy, sec-butoxy, tert-butoxy, n-pentoxy, isopentoxy, n-hexoxy and isohexoxy, particularly preferably methoxy or ethoxy
   C₁-C₁₂-alkyl, preferably methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl such as methyl, ethyl, n-propyl, isopropyl, n-butyl, isobutyl, sec-butyl and tert-butyl,
   C₂-C₁₈-acyl, for example acetyl, propionyl, butyryl, benzoyl, stearyl,
   or aryloxycarbonyl having 7 to 12 carbon atoms, for example C₆H₅—OCO.

Examples of particularly well suited HALS are
4-amino-2,2,6,6-tetramethylpiperidine,
4-amino-1,2,2,6,6-pentamethylpiperidine,
4-hydroxy-2,2,6,6-tetramethylpiperidine,
4-hydroxy-1,2,2,6,6-pentamethylpiperidine,
4-butylamino-2,2,6,6-tetramethylpiperidine,
4-butylamino-1,2,2,6,6-pentamethylpiperidine,
4-amino-2,2,6,6-tetramethylpiperidine-N-oxyl,
4-hydroxy-2,2,6,6-tetramethylpiperidine-N-oxyl,
4-butylamino-2,2,6,6-tetramethylpiperidine-N-oxyl,
4-hydroxy-2,2,6,6-tetramethyl-1-oxytoxypiperidine,
4-amino-2,2,6,6-tetramethyl-1-oxytoxypiperidine,
4-butylamino-2,2,6,6-tetramethyl-1-octoxypiperidine,
4-acetoxy-2,2,6,6-tetramethylpiperidine,
4-stearyloxy-2,2,6,6-tetramethylpiperidine,
4-aryloyloxy-2,2,6,6-tetramethylpiperidine,
4-methoxy-2,2,6,6-tetramethylpiperidine,
4-benzoyloxy-2,2,6,6-tetramethylpiperidine,
4-cyclohexyloxy-2,2,6,6-tetramethylpiperidine,
4-phenoxy-2,2,6,6-6-tetramethylpiperidine,
4-benzoxy-2,2,6,6-tetramethylpiperidine, and
4-(phenylcarbamoyloxy)-2,2,6,6-tetramethylpiperidine.

Likewise preferred HALS are:
bis(2,2,6,6-tetramethyl-4-piperidyl) oxalate,
bis(2,2,6,6-tetramethyl-4-piperidyl) succinate,
bis(2,2,6,6-tetramethyl-4-piperidyl) malonate,
bis(2,2,6,6-tetramethyl-4-piperidyl) adipate,
bis(1,2,2,6,6-pentamethylpiperidyl) sebacate,
bis(2,2,6,6-tetramethyl-4-piperidyl) terephthalate,
1,2-bis(2,2,6,6-tetramethyl-4-piperidyloxy)ethane,
bis(2,2,6,6-tetramethyl-4-piperidyl)hexamethylene 1,6-dicarbamate,
bis(1-methyl-2,2,6,6-tetramethyl-4-piperidyl) adipate, and
tris(2,2,6,6-tetramethyl-4-piperidyl)benzene 1,3,5-tricarboxylate.

Moreover, preference is given to relatively high molecular weight piperidine derivatives, e.g. the polymer of dimethyl butanedioate and 4-hydroxy-2,2,6,6-tetramethyl-1-piperidinethanol or poly-6-(1,1,3,3-tetramethylbutyl)amino-1,3,5-triazine-2,4-diyl(2,2,6,6-tetramethyl-4-piperidinyl)imino-1,6-hexanediyl(2,2,6,6-tetramethyl-14-piperidinyl)imino, and polycondensates of dimethyl succinate and 1-(2-hydroxyethyl)-4-hydroxy-2,2,6,6-tetramethylpiperidine, which, like bis(2,2,6,6-tetramethyl-4-piperidyl) sebacate, are particularly well suited.

Of very particularly high suitability are 4-amino-2,2,6,6-tetramethylpiperidine, 4-amino-1,2,2,6,6-pentamethylpiperidine, 4-hydroxy-2,2,6,6-tetramethylpiperidine, 4-hydroxy-1,2,2,6,6-pentamethylpiperidine, 4-amino-2,2,6,6-tetramethylpiperidine-N-oxyl and 4-hydroxy-2,2,6,6-tetramethylpiperidine-N-oxyl.

Suitable effect substances are furthermore preferably antioxidants.

The following are used for example as antioxidants:

alkylated monophenols such as, for example, 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, unbranched or side-chain-branched nonylphenols such as, for example, 2,6-dinonyl-4-methylphenol, 2,4-dimethyl-6-(1-methylundec-1-yl)phenol, 2,4-dimethyl-6-(1-methylheptadec-1-yl)phenol, 2,4-dimethyl-6-(1-methyltridec-1-yl)phenol and mixtures thereof.

Alkylthiomethylphenols such as, for example, 2,4-dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonylphenol.

Hydroquinones and alkylated hydroquinones such as, for example, 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

Tocopherols, such as, for example, α-tocopherol, β-tocopherol, γ-tocopherol, δ-tocopheroland mixtures thereof (vitamin E).

Hydroxylated thiodiphenyl ethers such as, for example, 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

Alkylidene-bisphenols such as, for example, 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl) butane, 2,6-bis(3-tert-butyl-5-methyl-2-hydroxybenzyl)-4-methylphenol, 1,1,3-tris(5-tert-butyl-4-hydroxy-2-methylphenyl) butane, 1,1-bis(5-tert-butyl-4-hydroxy-2-methylphenyl)-3-n-dodecylmercaptobutane, ethylene glycol bis[3,3-bis(3-tert-butyl-4-hydroxyphenyl)butyrate], bis(3-tert-butyl-4-hydroxy-5-methylphenyl) dicyclopentadiene, bis[2-(3′-tert-butyl-2-hydroxy-5-methylbenzyl)-6-tert-butyl-4-methylphenyl]terephthalate, 1,1-bis(3,5-dimethyl-2-hydroxyphenyl) butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra(5-tert-butyl-4-hydroxy-2-methylphenyl)pentane.

Benzyl compounds such as, for example, 3,5,3′,5′-tetra-tert-butyl-4,4′-dihydroxydibenzyl ether, octadecyl-4-hydroxy-3,5-dimethylbenzylmercaptoacetate, tridecyl 4-hydroxy-3,5-di-tert-butylbenzylmercaptoacetate, tris(3,5-di-tert-butyl-4-hydroxybenzyl)amine, 1,3,5-tri-(3,5-di-tert-butyl-4-hydroxybenzyl)-2,4,6-trimethylbenzene, di-(3,5-di-tert-butyl-4-hydroxybenzyl) sulfide, isooctyl 3,5-di-tert-butyl-4-hydroxybenzylmercaptoacetate, bis(4-tert-butyl-3-hydroxy-2,6-dimethylbenzyl)dithiol terephthalate, 1,3,5-tris(3,5-di-tert-butyl-4-hydroxybenzyl) isocyanurate, 1,3,5-tris(4-tert-butyl-3-hydroxy-2,6-dimethylbenzyl) isocyanurate, 3,5-di-tert-butyl-4-hydroxybenzylphosphoric acid dioctadecyl ester and 3,5-di-tert-butyl-4-hydroxybenzylphosphoric acid monoethyl ester, calcium salt.

Hydroxybenzylated malonates such as, for example, dioctadecyl 2,2-bis(3,5-di-tert-butyl-2-hydroxybenzyl)malonate, dioctadecyl-2-(3-tert-butyl-4-hydroxy-5-methylbenzyl)malonate, didodecyl mercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

Hydroxybenzyl aromatics such as, for example, 1,3,5-tris(3,5-di-tert-butyl-4-hydroxybenzyl)-2,4,6-trimethylbenzene, 1,4-bis(3,5-d i-tert-butyl-4-hydroxybenzyl)-2,3,5,6-tetramethylbenzene, 2,4,6-tris(3,5-di-tert-butyl-4-hydroxybenzyl)phenol.

Triazine compounds such as, for example, 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris-(3,5-di-tert-butyl-4-hydroxybenzyl) isocyanurate, 1,3,5-tris(4-tert-butyl-3-hydroxy-2,6-dimethylbenzyl) isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazine, 1,3,5-tris(3,5-dicyclohexyl-4-hydroxybenzyl) isocyanurate.

Benzylphosphonates such as, for example, dimethyl 2,5-di-tert-butyl-4-hydroxybenzylphosphonate, diethyl 3,5-di-tert-butyl-4-hydroxybenzylphosphonate (diethyl (3,5-bis(1,1-dimethylethyl)-4-hydroxyphenyl)methyl)phosphonate), dioctadecyl 3,5-di-tert-butyl-4-hydroxybenzylphosphonate, dioctadecyl 5-tert-butyl-4-hydroxy-3-methylbenzylphosphonate, calcium salt of monoethyl 3,5-di-tert-butyl-4-hydroxybenzylphosphonate.

Acylaminophenols such as, for example, 4-hydroxylauranilide, 4-hydroxystearanilide, 2,4-bisoctylmercapto-6-(3,5-tert-butyl-4-hydroxyanilino)-s-triazine and octyl N-(3,5-di-tert-butyl-4-hydroxyphenyl)carbamate.

Esters of β-(3,5-di-tert-butyl-4-hydroxyphenyl)propionic acid with monohydric or polyhydric alcohols, such as e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

Esters of β-(5-tert-butyl-4-hydroxy-3-methylphenyl)propionic acid with monohydric or polyhydric alcohols, such as e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

Esters of β-(3,5-dicyclohexyl-4-hydroxyphenyl)propionic acid with monohydric or polyhydric alcohols such as e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

Esters of 3,5-di-tert-butyl-4-hydroxyphenylacetic acid with monohydric or polyhydric alcohols, such as e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

Amides of β-(3,5-di-tert-butyl-4-hydroxyphenyl)propionic acid, such as e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyphydrazide, N,N′-bis[2-(3-[3,5-di-tert-butyl-4-hydroxyphenyl]propionyloxy)ethyl]oxamide (e.g. Naugard®XL-1 from Uniroyal).

### Ascorbic Acid (Vitamin C)

Aminic antioxidants, such as, for example, N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl) biguanide, bis[4-(1′,3′-dimethylbutyl)phenyl]amine, tert-octylated N-phenyl-1-naphthylamine, mixture of mono- and dialkylated tert-butyl/tert-octyldiphenylamines, mixture of mono- and dialkylated nonyldiphenylamines, mixture of mono- and dialkylated dodecyldiphenylamines, mixture of mono- and dialkylated isopropyl/isohexyldiphenylamines, mixture of mono- and dialkylated tert-butyldiphenylamines, 2,3-dihydro-3,3-dimethyl-4H-1,4-benzothiazine, phenothiazine, mixture of mono- and dialkylated tert-butyl/tert-octylphenothiazines, mixture of mono- and dialkylated tert-octylphenothiazines, N-allylphenothiazine, N,N,N′,N′-tetraphenyl-1,4-diaminobut-2-ene, N,N-bis(2,2,6,6-tetramethylpiperidin-4-yl)hexamethylenediamine, 2,2,6,6-tetramethylpiperidin-4-one, 2,2,6,6-tetramethylpiperidin-4-ol, the dimethyl succinate polymer with 4-hydroxy-2,2,6,6-tetramethyl-1-piperidinethanol [CAS Number 65447-77-0], (for example Tinuvin® 622 from Ciba Specialty Chemicals, Inc.), polymer of 2,2,4,4-tetramethyl-7-oxa-3,20-diazadispiro[5.1.11.2]heneicosan-21-one and epichlorohydrin [CAS No.: 202483-55-4], for example (Hostavin® N 30 from Clariant).

As antioxidants, particular preference is given to using Irganox 1010 (CAS 6683-19-8) benzenepropanoic acid, 3,5-bis(1,1-dimethylethyl)-4-hydroxy-, 2,2-bis[[3-[3,5-bis(1,1-dimethylethyl)-4-hydroxyphenyl]-1-oxopropoxy]methyl]-1,3-propanediyl ester, Irganox 1076 (CAS 2082-79-3) octadecyl 3-(3,5-di-tert-butyl-4-hydroxyphenyl)propionate and Irganfos 168 (CAS 31570-04-4)tris(2,4-di-tert-butylphenyl) phosphite.

Further phosphitic antioxidants can be found on pages 217-225 of the publication by B. Marcatoa, et al. in the International Journal of Pharmaceutics Vol. 257 (1-2), 2003.

As effect substances, preference is given to using mixtures of UV absorbers and HALS compounds.

Within the context of the mixture according to the invention, suitable inorganic, compounds are a broad palette of substances which have agglomerates with the properties described above. The inorganic compounds are usually commercially available.

The inorganic compounds are often selected from the substance group of oxides, carbonates, hydrogencarbonates, phosphates, sulfates, hydroxides, silicates, or sulfides. Preferably, the inorganic compounds are selected from the substance group of oxides, carbonates or silicates. In particular, they are silicates or carbonates.

Furthermore, the inorganic compounds generally comprise alkali metals and/or alkaline earth metals and/or transition metals, in particular calcium. Preferably, the inorganic compound comprises from 50 to 100% by weight of CaCO₃, based on the total amount of inorganic compound, preferably 70 to 100% by weight, in particular 90 to 100% by weight. Very preferably, the inorganic compound comprises essentially CaCO₃, or consists of CaCO₃.

In a preferred embodiment of the mixture according to the invention, the inorganic compounds comprise Mg, Al, Si, Ti, Ge, Zr or mixtures of these. Preferably, the inorganic compound comprises from 50 to 100% by weight of SiO₂, based on the total amount of inorganic compound, preferably 70 to 100% by weight, in particular 90 to 100% by weight. Very preferably, the inorganic compound comprises essentially SiO₂, or consists of SiO₂ (silica).

In a further preferred embodiment of the mixture according to the invention, the inorganic compounds comprise amorphous precipitated silica (as described e.g. in WO 94/010087). Preferably, the inorganic compound comprises from 50 to 100% by weight of amorphous precipitated silica, based on the total amount of inorganic compound, preferably 70 to 100% by weight, in particular 90 to 100% by weight. Very preferably, the inorganic compound comprises essentially amorphous precipitated silica, or consists of amorphous precipitated silica. Further preferably, the amorphous precipitated silica is a silica which has been hydrophobicized by means of an organosilicon compound. The process is described in DE 1172245 (page 2).

The present invention further provides a process for producing the mixtures according to the invention, where the inorganic compounds are brought into contact with the effect substances and the effect substances are in the liquid or at least plastic state and the inorganic compounds absorb the effect substances essentially completely.

Preferably, one of the following processes can be used:
1. Melting the effect substances in a kneader, adding the inorganic compounds, using the kneader to distribute the effect substance into the pores of the inorganic compounds until the effect substance has been taken up as completely as possible, cooling and pulverizing the mixture.
2. Initial introduction of the inorganic compounds and heating in a kneader, addition of the effect substances, distribution of the effect substance into the pores of the inorganic compound until the effect substance has been taken up as completely as possible, cooling and pulverizing the mixture.
3. Softening/dissolving the effect substances in a solvent or with the help of a plasticizer, addition of the inorganic compounds, distribution of the effect substance into the pores of the inorganic compound with stirring until the effect substance has been taken up as completely as possible, stripping off the solvent, possibly in vacuo, cooling and pulverizing the mixture.

The present invention further provides the use of the mixtures according to the invention comprising, as effect substances, UV absorbers and/or stabilizers, in particular HALS or antioxidants, in the finishing of plastics for protecting against oxidative, thermal and/or light-induced degradation.

Preference is given to using the mixtures according to the invention comprising UV absorbers for protecting inanimate organic materials against the effect of UV radiation.

Furthermore, preference is given to the use of the mixtures according to the invention comprising stabilizers, in particular HALS or antioxidants, for protecting inanimate organic materials against the effect of heat, free radicals or oxygen.

In particular, within the context of the use for protecting against oxidative, thermal and/or light-induced degradation, the inanimate organic materials are plastics (polymers), coatings or coating raw materials, in particular polymers. Coating raw materials are constituents of mixtures (coatings) which are cured to give coating layers. Polymers, coatings and coating raw materials are known to the person skilled in the art from the prior art.

Examples of polymers are:

1. Polymers of monoolefins and diolefins, such as, for example, polypropylene, polyisobutylene, polybut-1-ene, poly-4-methylpent-1-ene, polyisoprene or polybutadiene; likewise polymers of cycloolefins, such as for example polycyclopentene or polynorbornene; polyethylene (which may be optionally crosslinked), such as, for example, HDPE, HDPE-H, HDPE-UHMW, MDPE, LDPE, LLDPE, BLDPE, VLDPE and ULDPE;
2. Mixtures of polymers as described under point 1, such as, for example, mixtures of polypropylene with polyisobutylene; mixtures of polypropylene with polyethylene, for example PP/HDPE, PP/LDPE; mixtures of different types of polyethylene, for example LDPE/HDPE.
3. Copolymers of monoolefins and diolefins with one another or with other vinyl-containing monomers. Examples of such copolymers are ethylene/propylene copolymers, LLDPE and its mixtures with LDPE, propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide or ethylene/acrylic acid copolymers and their salts (ionomers) and also terpolymers of ethylene with propylene and a diene, such as for example, hexadiene, dicyclopentadiene or ethylidenenorbornene; likewise mixtures of the specified copolymers with one another or with the polymers listed under point 1, such as, for example, polypropylene/ethylene/propylene copolymers, LDPE/ethylene/vinyl acetate (EVA) copolymers, LDPE/ethylene/acrylic acid (EU) copolymers, LLDPE/EVA, LLDPE/EAA and alternating or random polyalkylene/carbon monoxide copolymers and their mixtures with other polymers, such as e.g. polyamides.
4. Polystyrene, poly(p-methylstyrene), poly(α-methylstyrene).
5. Copolymers of styrene or α-methylstyrene with dienes or acrylic acid derivatives, such as for example styrene/butadiene, styrene/acrylonitrile, styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength between styrene copolymers and other polymers, such as, for example, polyacrylates, diene polymers or ethylene/propylene/diene terpolymers, block copolymers of styrene, such as, for example, styrene/butadiene/styrene, styrene/isoprene/styrene, styrene/ethylene/butylene/styrene or styrene/ethylene/propylene/styrene.
6. Graft copolymers of styrene or α-methylstyrene, such as, for example, styrene in polybutadiene, styrene in polybutadiene/styrene or polybutadiene/acrylonitrile copolymers; styrene and acrylonitrile (or methacrylonitrile) in polybutadiene; styrene, acrylonitrile and methyl methacrylate in polybutadiene; styrene and maleic anhydride in polybutadiene; styrene, acrylonitrile and maleic anhydride or maleimide in polybutadiene; styrene and maleimide in polybutadiene; styrene and alkyl acrylates or alkyl methacrylates in polybutadiene; styrene and acrylonitrile in ethylene/propylene/diene terpolymers, styrene and acrylonitrile in polyalkyl acrylates or polyalkyl methacrylates, styrene and acrylonitrile in acrylate/butadiene copolymers, and also mixtures of copolymers which have been listed under point 5, such as, for example, mixtures of known copolymers, such as ABS, MBS, ASA or AES.
7. Halogen-containing polymers, such as, for example, polychloroprene, chlorinated elastomers, chlorinated or brominated isobutylene/isoprene copolymers (“halobutyl rubber”), chlorinated or chlorosulfonated polyethylene, ethylene and chlorinated ethylene copolymers, homopolymers and copolymers of epichlorohydrin, in particular polymers of halogen-containing vinyl compounds, such as, for example, polyvinyl chloride, polyvinylidene chloride, polyvinyl fluoride or polyvinylidene fluoride; likewise their copolymers, for example based on vinyl chloride/vinylidene chloride, vinyl chloride/vinyl acetate or vinylidene chloride/vinyl acetate.
8. Polymers derived from α,β-unsaturated acids and their derivatives, such as, for example, polyacrylates and polymethacrylates, polymethyl methacrylates, polyacrylamides and polyacrylonitriles, impact-modified with butyl acrylate.
9. Copolymers based on monomers from point 8. with one another or with other unsaturated monomers, such as, for example, acrylonitrile/butadiene copolymers, acrylonitrile/alkyl acrylate copolymers, acrylonitrile/alkoxyalkyl acrylate copolymers or acrylonitrile/vinyl halide copolymers or acrylonitrile/alkyl methacrylate/butadiene terpolymers.
10. Polymers derived from unsaturated alcohols and amines or their acyl or acetal derivatives, such as, for example, polyvinyl alcohol, polyvinyl acetate, polyvinyl stearate, polyvinyl benzoate, polyvinyl maleate, polyvinylbutyral, polyallyl phthalate or polyallylmelamine; likewise their copolymers with the olefins listed under point 1.
11. Homopolymers and copolymers of open-chain or cyclic ethers, such as for example polyalkylene glycols, polyethylene oxide, polypropylene oxide or copolymers of the compounds described above with bisglycidyl ethers.
12. Polyacetals, such as, for example, polyoxymethylene or comonomers comprising polyoxymethylene, for example ethylene oxide; with thermoplastic polyurethanes, acrylates or MBS modified polyacetals.
13. Polyphenylene oxides and sulfides and their mixtures with: styrene polymers or polyamides.
14. Polyurethanes derived from hydroxy-terminated polyethers, polyesters or polybutadienes on the one hand and aliphatic or aromatic polyisocyanates on the other hand and their respective precursor compounds.
15. Polyamides and copolyamides, derived from diamines and dicarboxylic acids and/or aminocarboxylic acids or corresponding lactams, such as, for example, Polyamide 4, Polyamide 6, Polyamide 6/6, 6/10, 6/9, 6/12, 4/6, 12/12, Polyamide 11, Polyamide 12, aromatic polyamides starting from m-xylenediamines and adipic acid; polyamides starting from hexamethylenediamine and isophthalic acid and/or terephthalic acid and with or without an elastomer as modifier, such as, for example, poly-2,4,4-trimethylhexamethyleneterephthalamide or poly-m-phenyleneisophthalamide; likewise block copolymers of the above polyamides with polyolefins, olefinic copolymers, ionomers or elastomers, chemically bonded or grafted, or with polyethers, such as, for example, polyethylene glycol, polypropylene glycol or polytetramethylene glycol; likewise polyamides or copolyamides modified with EPDM or ABS and polyamides condensed during the processing (“RIM-polyamide system”).
16. Polyureas, polyimides, polyamide imides, polyether imides, polyester imides, polyhydantoins and polybenzoimidazoles.
17. Polyesters derived from dicarboxylic acids and diols and/or from hydroxycarboxylic acids or the corresponding lactones, such as, for example, polyethylene terephthalate, polybutylene terephthalate, poly-1,4-dimethylolcyclohexane terephthalate and polyhydroxybenzoates, likewise block copolyether esters which are derived from polyethers with hydroxyl-terminated groups, and also polyesters modified with polycarbonates or MBS.
18. Polycarbonates and polyester carbonates.
19. Polysulfones, polyether sulfones and polyether ketones.
20. Crosslinked polymers which are derived on the one hand from aldehydes and on the other hand from phenols, urea and melamines, such as, for example, phenol/formaldehyde, urea/formaldehyde and melamine/formaldehyde resins.
21. Dried and undried alkyd resins.
22. Resins based on unsaturated polyesters which are derived from copolyesters of saturated and unsaturated carboxylic acids with polyhydric alcohols and vinyl compounds as crosslinkers, likewise the above-mentioned halogen-containing flame-resistant resins.
23. Crosslinkable acrylic resins derived from substituted acrylates, such as, for example, epoxyacrylates, urethane acrylates or polyester acrylates.
24. Alkyd resins, resins based on polyesters or acrylated resins crosslinked with melamine, resins based on urea, resins based on isocyanates, resins based on isocyanurates, resins based on polyisocyanates or epoxy resins.
25. Crosslinked epoxy resins derived from aliphatic, cycloaliphatic, heterocyclic or aromatic glycidyl compounds, such as, for example, products of diglycidyl ethers of bisphenol A and bisphenol F which are crosslinked with customary crosslinkers, such as, for example, anhydrides or amines in the presence or absence of accelerators.
26. Naturally occurring polymers, such as, for example, cellulose, gum, gelatin and their derivatives chemically modified to achieve homologous products, such as, for example, cellulose acetate, propionate and butyrate, or cellulose ethers, such as, for example, methylcellulose; likewise hydrocarbon resins (“rosins”) and their derivatives.
27. Mixtures of said polymers (“polyblends”), such as, for example, PP/EPDM, polyamides/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylates, POM/MBS, PPO/HIPS, PPO/PA 6.6 and copolymers, PA/HDPE, PAPP, PAPPO, PBT/PC/ABS, PBT/PET/PC.
28. Natural or synthetic organic materials which are pure monomeric compounds, and also mixtures thereof, such as, for example, mineral oils, animal or vegetable oils, fats or waxes, oils, fats or waxes based on synthetic esters, e.g. phthalates, adipates, phosphates and trimellitates, and also mixtures of synthetic esters with mineral oils in any desired weight ratios, and also aqueous emulsions of the specified organic materials.
29. Aqueous emulsions of natural or synthetic gums, such as, for example, natural latex or latices based on carboxylated styrene/butadiene copolymers.

The polymers are preferably polyolefins, in particular polyethylene or polypropylene, specifically LDPE, LLDPE, or EPDM or PVC.

The invention further provides inanimate organic materials comprising the above-described embodiments of the mixtures according to the invention. Emphasis is given to plastics comprising the mixtures according to the invention, where the effect substances are stabilizers or UV absorbers and the inorganic compounds comprise CaCO₃ and/or SiO₂.

The mixtures according to the invention can be incorporated into the inanimate organic materials in a manner known to the person skilled in the art. As a rule, the incorporation is effected by a mixing process or by an application to the surface of the materials. For this, in the case of the mixing process, for example extruders, kneaders or calenders can be used to produce the mixture, as described, for example, in Albrecht Müller, Einfärben von Kunststoffen [Dyeing plastics], Hanser Verlag, ISBN 3-446-21990-0. Of suitability for application to the surface are wetting and spraying processes, optionally combined with a drying step. Furthermore, the mixtures according to the invention can be incorporated into the inanimate organic materials by a “flush process”, as described for example in U.S. Pat. No. 4,088,577.

One advantage of the mixtures according to the invention is that they can be homogeneously distributed (dispersed) very readily in the inanimate organic materials, in particular plastics. This often leads to very slight clouding (haze) of the materials. Preferably, the inanimate organic materials comprising the mixtures according to the invention have a haze of 1-5%. Measuring the clouding in accordance with ISO 13803 takes place for example using a micro-haze plus measuring instrument, from Byk Gardner.

The content of mixtures according to the invention in the inanimate organic materials, in particular plastics, can vary over a wide range depending on the use or material. As a rule, the content is from 100 ppm to 10% by weight of the mixture according to the invention, based on the total amount of mixture according to the invention and inanimate organic material. Preferably, the content is from 150 ppm to 8% by weight, very particularly preferably from 200 ppm to 7% by weight and in particular from 200 ppm to 3% by weight.

The invention further provides methods for stabilizing inanimate organic materials, where mixtures according to the invention as per the embodiments described above are added to the inanimate organic materials in an effective amount. As a rule, the effective amount is from 100 ppm to 10% by weight of the mixture according to the invention, based on the total amount of mixture according to the invention and inanimate organic material. Preferably, the effective amount is from 150 ppm to 8% by weight, very particularly preferably from 200 ppm to 7% by weight and in particular from 200 ppm to 3% by weight.

The invention further provides the use of inorganic compounds as carriers for effect substances, where the inorganic compounds correspond to the inorganic compounds of the mixtures according to the invention and are thus present as agglomerates and these agglomerates have
a. a specific surface area greater than 10 m²/g,
b. a particle size of from 1 to 20 μm,
c. a loss on ignition of from 1 to 20%,
d. a carbon content of from 0.1 to 5%,
e. a methanol wettability of from 10 to 90%,
f. an effect substance absorption of from 100 g to 4000 g, based in each case on 100 g of inorganic compound.

Further particularly preferred embodiments of the inorganic compounds have already been described within the context of the embodiments of the mixture according to the invention.

With the aid of the mixtures according to the invention, an increased migration stability of effect substances in inanimate organic materials is achieved. This brings advantages both for the end use (e.g. extended life of the materials, reduced escape of effect substances into the environment) and also during the processing and preparation of the materials (lower loss of effect substances themselves coupled with homogeneous distribution). Also during the formation of a coating layer and during the use of these layers, the loss of effect substances is minimal.

The examples below are intended to illustrate the invention, but not limit it.

Properties of Sipernat® D 17 from Evonik:
specific surface area: 100 m²/g, particle size: 10 μm, loss on ignition: 7%, carbon content 2%, methanol wettability of 55%.

### EXAMPLE 1

In a 10 l laboratory kneader from IKA—Werke of 79219 Staufen, Germany, 4750 g of the effect substance Uvinul® 3008 (Chimassorb® 81, 2-hydroxy-4-octoxybenzophenone) were heated to 60° C. and then 250 g of Sipernat® D 17 from Evonik were added as inorganic compound. The mixture was then kneaded at an internal temperature of 48° C. for 2 hours and then cooled. This gave 4.63 kg (effect substance absorption: 1752 g of Uvinul® 3008, based on 100 g of Sipernat® D17) of a pale powder.

In a twin-screw extruder, 0.526 g of the aforementioned powder and 0.2 g of Uvinul® 5050 H (oligomeric, sterically hindered amine, CAS No. 152261-33-1) were then compounded at a temperature of 200° C. together with 99.3 g of Lupolen® 1840 D (LD polyethylene from Basell), giving a homogeneous melt and then homogeneous granules. This was used to blow a film with a thickness of ca. 100 μm. On this film, firstly the reference UV-vis spectrum between 200 and 800 nm was measured. The film was weathered in accordance with ISO 4892-2. After the times stated in Table 1, the transmission was measured at three different wavelengths λ (330 nm, 280 nm and 240 nm).

Even after long exposure times, a considerable UV absorption (low transmission) of the films can still be observed.

TABLE 1

| | |
|---|---|
| Exposure | Transmissions in % at wavelengths λ |

| | | | |
|---|---|---|---|
| time | 330 nm | 280 nm | 240 nm |

| | | | | |
|---|---|---|---|---|
| 0 | h | 4 | 0 | 2 |
| 1000 | h | 5 | 2 | 2 |
| 2000 | h | 7 | 2 | 4 |
| 3000 | h | 10 | 4 | 6 |
| 4000 | h | 23 | 10 | 12 |
| 5000 | h | 28 | 16 | 17 |
| 6000 | h | 39 | 27 | 25 |
| 8000 | h | 55 | 38 | 32 |

We claim:

1. A mixture comprising inorganic compounds and effect substances, where the inorganic compounds are present as agglomerates and these agglomerates have
a. a specific surface area greater than 10 m²/g,
b. a particle size of from 1 to 20 μm,
c. a loss on ignition of from 1 to 20%,
d. a carbon content of from 0.1 to 5%,
e. a methanol wettability of from 10 to 90%,
f. an effect substance absorption of from 100 g to 4000 g, based on 100 g of inorganic compound.

2. The mixture according to claim 1, where the agglomerates have the maximum of the differential pore volume at an average pore diameter of from 30 to 60 nm.

3. The mixture according to claim 1 or 2, where an amount of 5 to 99% by weight of effect substances, based on the total amount of effect substances and inorganic compound in the mixture, is present.

4. The mixture according to claims 1 to 3, where the effect substances are UV-absorbers, stabilizers, antioxidants, flame retardants, antifogging additives, lubricants, plasticizers, antistats, dyes, optical brighteners, IR dyes or biocides.

5. The mixture according to claims 1 to 4, where the inorganic compounds are selected from the group of oxides, carbonates, hydrogencarbonates, phosphates, sulfates, hydroxides, silicates and sulfides.

6. The mixture according to claims 1 to 5, where the inorganic compounds comprise alkaline earth metals.

7. The mixture according to claim 6, where the inorganic compound comprises essentially CaCO₃.

8. The mixture according to claims 1 to 5, where the inorganic compounds comprise Mg, Al, Si, Ti, Ge, or Zr.

9. The mixture according to claim 8, where the inorganic compound comprises essentially SiO₂.

10. The mixture according to claim 8 or 9, where the inorganic compound comprises amorphous precipitated silica which has been hydrophobicized by means of an organosilicon compound.

11. A process for producing mixtures according to claims 1 to 10, wherein the inorganic compounds are brought into contact with the effect substances, where the effect substances are in the liquid or at least plastic state and the inorganic compounds absorb the effect substances essentially completely.

12. An agglomerate of inorganic compounds comprising effect substances produced according to claim 11.

13. The use of mixtures according to claim 4 during the processing or the use of inanimate organic materials.

14. The use of mixtures according to claim 4 for protecting inanimate organic materials against oxidative, thermal or light-induced degradation or the effect of UV radiation.

15. The use according to claim 13 or 14, where the inanimate organic materials are polymers, coatings or coating raw materials.

16. An inanimate organic material comprising mixtures according to claims 1 to 10.

17. A method for stabilizing inanimate organic materials, wherein mixtures according to claim 4 are added to the inanimate organic materials in an effective amount.

18. The use of inanimate compounds according to claim 1 or 2, as carriers for effect substances.
